(19) United States
(12) Patent Application Publication
(10) Pub. No.: US 2009/0208618 A1
(43) Pub. Date: Aug. 20, 2009

(54) Method for processing raw materials having a cell structure in the meat, meat by-products, fish and seafood processing industry

(75) Inventor: Fritz Kortschack, Berlin (DE)

Correspondence Address: BODNER & O'ROURKE, LLP, 425 BROADHOLLOW ROAD, SUITE 108, MELVILLE, NY, 11747, US

(73) Assignee: Triton GmbH, Berlin (DE)

(21) Appl. No.: 11/990,895

(22) PCT Filed: Aug. 22, 2006
(86) PCT No.: PCT/EP2006/065538

§ 371 Date: Apr. 20, 2009

(30) Foreign Application Priority Data
Aug. 24, 2005 (DE) 10 2005 040 082.5
Dec. 29, 2005 (DE) 10 2005 062 933.4

(51) Int. Cl. A23L 3/00

(52) U.S. Cl. 426/244

(57) ABSTRACT

The invention relates to a method for processing raw materials having a cell structure in the meat, meat by-products, fish and seafood processing industry for the purpose of optimizing and/or reducing the processing steps. According to the invention, an electric field with a field strength of >0.5 kV/cm is applied and an energy input into the cell structure product to be processed with an energy upper limit is produced, said energy input excluding thermal effects as a primary cause of occurring product modifications. Electroporation of the cell membrane occurs, the semi-permeability of the cell membrane and thus the barrier of transport of substances between the cell interior and the exterior is reversibly or irreversibly lifted. An accelerated and evenly distributed reception of liquid media in the produced porous cell matrix by injection or marination is then possible, whereby further substances which determine the product properties can be dissolved or contained in the liquid media. The mass transport within the tissue, which has been improved due to the electroporation, can also be used for the accelerated removal of water by applying suitable driving forces such as vacuum or a corresponding concentration gradient.

The invention relates to a method for treating raw materials having a cell structure in the meat, meat by-product, fish and seafood processing food industry for the purpose of optimizing and/or reducing processing steps according to the preamble of patent claim 1.

In the production of raw cured products the professional choice of the raw material plays an important role for the quality criteria. Thus, reddening, preservability, color retention and flavor are influenced by the exact material choice. Since a raw cured product is a product preserved by salting, drying and possibly also by smoking, hygiene plays a significant part for the production and treatment of raw materials. The binding of water in cooked cured products is, similar to the production of scalded sausages, jellied meat and cooked sausages, limiting for a reduction of the applied quantities of auxiliary curing agents or common salt. pH-values and aW-values are thereby affected in a similar way. Cooked cured products such as cooked ham, shoulder or cured pork are usually produced by injecting brine and a subsequent mechanical massage (tumbling). Raw sausages are produced from raw beef or pork, sturdy bacon, salt and spices. To obtain the raw sausage meat, the meat and bacon are minced in a cutting bowl with rotating knives (cutter) or in a mincer until the desired granulation is reached. After adding salt and spices and/or technical additives the sausage material is filled into sausage casings, which should be breathable, permeable to water and vapor as well as flexible because the sausages release water in the course of the maturation and are subject to shrinkage.

Scalded sausages are, just like raw sausages, produced from raw minced beef or pork, bacon as well as salt and spices. Crushed ice is added as the meat is minced in the cutter, which cools the sausage material and helps to obtain a uniform, homogeneous meat mixture. Red types of scalded sausages are produced with the addition of pickling salt, while the white types such as pork and veal sausage, Bavarian veal sausage as well as frying sausages are exclusively produced with common salt. Scalded sausages differ in dependence on how finely the sausage meat was cut and whether chunky meat pieces were added. The sausages are then scalded and partially smoked. When scalding them in hot water or water vapor, the protein in the meat coagulates and solidifies so that the sausage becomes cuttable. To loosen the connective tissue and the muscle fibers of cooked cured products as well as to achieve a partial disintegration of the protein the so-called beating (tumbling) is applied. Correspondingly treated raw materials can steep more strongly, the binding of water is improved and the bonding of particulate portions, as is required for example in the production of molded ham, is improved. Additionally, the tumbling increases the tenderness and effects a better and faster distribution of added curing and auxiliary substances. Tests have shown, however, that also a tumbled raw material only allows an insufficient steeping of the protein volume and a relatively non-uniform texture, so that sufficient successes with respect to tenderness, the disintegration of protein and the binding of water can only be guaranteed by the addition of auxiliary cutter agents. Such auxiliary cutter agents are, for example, phosphate-containing substances.

To obtain a sufficient cutting or tumbling effect, the fabrication and production process not only requires a high input of mechanical energy, which involves thermal damages to the product, but also a considerable expenditure of time. This leads to higher costs, especially because of the necessary cooling of the corresponding machines.

The effect of electric fields for the purpose of electroporation especially of vegetable cell membranes is already known from the publication Angersbach, Heinz, Knorr; “Effects of pulsed electric fields on cell membranes in real food systems”; Innovative Food Science & Emerging Technologies 1 (2000), pages 135 to 149, or from Angersbach, Heinz, Knorr; Electrophysiological Model of Intact and Processed Plant Tissues: Cell Disintegration Criteria; Biotechnol. Prog. 1999, 15, 753 to 762.

It is the object of the invention to provide a further developed method for treating raw materials having a cell structure in the meat, meat by-product, fish and seafood processing food industry for the purpose of optimizing and/or reducing processing steps, said method not only aiming at a reduction of the processing time of raw materials, but simultaneously contributing to the reduction of the usually required addition of tenderizing and/or water-binding additives. The method is to be suited both for the production and treatment of cooked cured products and, in general, also for the production of scalded sausages, jellied sausages, cooked sausages or the like.

The solution to the object according to the invention is achieved with the method defined in patent claim 1, with the dependent claims representing at least useful embodiments and advancements.

According to the invention, a pretreatment of the raw material such as meat or bowels is performed by means of electroporation, to ensure that the required cell and protein disintegration takes place thoroughly during a subsequent cutting and/or mincing process to be performed in less time.

Before, during or after the electroporation, possibly also other auxiliary substances can be added to the raw material by injecting brine, i.e. a water/salt mixture, but also by adding salt and water and/or auxiliary substances during the cutting or mincing, in a quantity required to obtain a stable emulsion. The electroporation ensures a thorough cell disintegration so that the cutting or mincing process is merely limited to the mincing and mixing of lean meat, salt, fat, spices, auxiliary substances and possible add-ins such as coarse ingredients. Thus, the production process can be accelerated as a whole. Also, it is possible to employ cutter knives, which contribute to a further reduction of the production process because of a defined beating effect.

The cutting process can be omitted if, for mincing the raw material, a mincer, filling and/or mixing mincer is employed, which is provided with appropriate (fine) punched discs and a suitable conveyor tool.

A pretreatment of coarse lean meat ingredients for the production of ham sausage, chasseur sausage or the like by means of electroporation and a subsequent injection of brine permits an optical upgrading of the final products because the volume of the meat shrinks to a smaller extent during the heating process due to the improved binding of water.

If, according to the invention, the meat is pretreated by means of electroporation, it is useful to employ or combine thereafter one (or more) (filling) mincer/mincers, because then merely the tasks of mincing and mixing the individual components have to be performed.

The electroporation is accomplished by applying an electric field having a field strength of >0.5 kV/cm and by the energy input resulting therefrom into the product to be processed, which has a cell structure.

The field effect reversibly or irreversibly eliminates the semi-permeability of the cell membrane.

The electroporated cell membrane and the associated elimination of the barrier to the transportation of substances between the cell interior and the exterior permits, as a result of accelerated diffusion and mass transportation processes, a uniform distribution of the brine liquid, which is either injected or provided by placing the raw product into the brine. The obtained porous matrix moreover increases the binding of water, whereby this effect can be improved even more by added electrolytes or other water-binding substances such as sugar, polysaccharides or the like. Furthermore, an absorption of spices, salt or auxiliary substances added in a dry state, which is practiced, for example, in the production of raw ham, can be accelerated in accordance with the invention as a result of the improved mass transportation within the cellular tissue.

In a preferred embodiment of the invention it is ensured that the electric energy to be applied is at least 5 kJ/kg of treated product. The upper limit of the energy input is determined in such a way that thermal effects do not represent the primary cause for modifications of the product structure.

The electric field is generated by coupling in, namely either by a direct contact with the aid of electrodes or by conductive fluids, whereby the products to be treated are placed into the conductive fluid as a whole or in part.

Due to the obtained porous structure and the so obtained higher binding of water it is possible in accordance with the invention to achieve an improved tenderness of the produced products.

It has surprisingly shown that the desired tenderness of meat is also achieved if no additional liquid is added to the product treated according to the invention after the electroporation.

In one embodiment of the invention it is possible to utilize the electroporation method and the cell disintegration resulting therefrom for the systematic removal of liquids. Such a removal of liquid serves as a supplementary product step for the producton of raw and durable products. The selective removal of water can be accomplished by applying suitable driving forces, such as a vacuum in the vacuum cutter, the vacuum mincer, but also in any other vacuum tank, as well as concentration gradients by applying hygroscopic materials and/or dry air or mechanical influences like pressing.

The elctroporation applied herein in accordance with the invention allows an accelerated, selective water removal in an environment largely devoid of germs, namely in a vacuum, whereby additional hygroscopic materials may be provided in the treatment area. Apart from conventional raw materials also very fresh, even freshly slaughtered meat pieces can be dehumidified systematically by using electroporation.

The electroporation supports particularly the processing of very fresh raw materials, such as freshly slaughtered meat, for the production of raw durable products, e.g. raw ham or raw sausage, thereby allowing the use of probiotic substances with the simultaneous reduction of the used quantities of common salt and nitrite or nitrate, respectively. The electroporation of the fresh raw material not only improves mass transportation processes and, if suitable driving forces are applied, the removal of humidity, but also substantially increases the degree of tenderness, whereby this property is also maintained during the further processing to raw cured products.

Accordingly, the electroporation according to the invention serves the improved and uniform absorption and binding of added liquids in products which, not minced and/or minced, are marketed only after another treatment, such as after tempering, smoking or incorporating them into other raw products.

However, the electroporation is also substantially advantageous if there is the aim to incorporate curing brine into cooked cured products in an efficient, method-optimizing manner, whereby the electroporation is possible before, during or after an injection of injection brine. In the production of cooked cured products, too, the electroporation improves the degree of tenderness. The raw product treated according to the embodiment is, after having been heated, supplied to the consumer as cooked cured product or cured pork.

In one embodiment of the invention is its possible to modify by means of electroporation the raw products with respect to their cell structure in such a way that liquids can be significantly absorbed from a surrounding bath, i.e. without injection, which is performed, for example, during marinating.

The invention shall be explained in more detail below by means of an embodiment and with reference to the drawing.

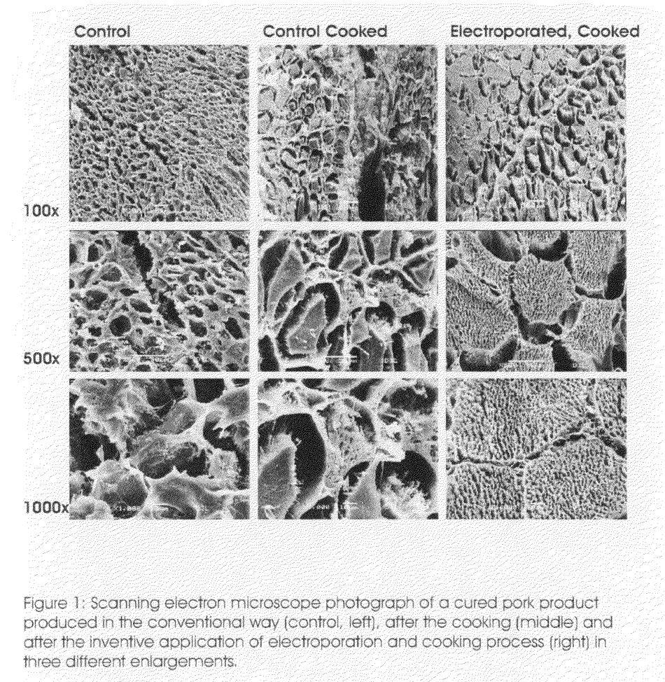

FIG. 1 shows a microscopic sectional photograph of a cured pork product produced in the conventional manner according to the prior art, i.e. tumbled and cooked. Another representation shows a similar cured pork product, which was subjected to an electroporation according to the invention prior to the tumbling and cooking.

It can be seen in the latter representation that the protein volume is expanded, the texture is better and more uniform, and the product quality as a whole is enhanced, all this without the necessity of adding auxiliary cutter substances.

In the method for treating raw materials having a cell structure in the meat and sausage processing food industry according to the embodiment described below the same is, at first, characterized in that an energy input into the product to be treated is accomplished by applying an electric field having a field strength of >0.5 kV/cm, whereby such a value is chosen as upper energy limit that ensures that modifications occurring in the product structure do not primarily have thermal causes.

With the aid of the electric field the cell membrane is electroporated, with the result that the barrier to the transportation of substances between the cell interior and the exterior is eliminated. By this step, both an accelerated and uniformly distributed absorption of liquid media by the created porous cell matrix can be realized, or, if suitable driving forces, e.g. a vacuum, or concentration gradients are applied, humidity can be removed from the cell matrix.

The liquid medium penetrating as a result of the electroporation into the cell matrix in an accelerated and uniformly distributed manner may contain additional substances that determine the product properties. The electroporation can, for example, be carried out in a liquid bath containing substances that modify the product properties.

If the electroporation is applied in the liquid bath, steps must be taken that the conductivity value of the bath is within a range suited for the pulse generation system, which is preferably adjusted to be lower than the conductivity of the raw material to be treated.

Alternatively, but also supplementally, the electric field may be applied by means of electrodes, e.g. needle, roller, grid, flow or plate type ones. In one embodiment of the invention, the needle electrodes have the shape of a cannula and can serve the simultaneous or time-shifted supply of injection liquid, e.g. injection brine.

The electroporation can be carried out before or after a liquid injection step or the marination, or simultaneously with or supplementally to this step, respectively.

It is also possible to treat raw sausage meat by means of electroporation and to process the so treated sausage meat further in a manner known per se, however, likewise with a reduced cutter period and possibly reduced quantities of used auxiliary cutter substances.

1. Method for treating raw materials having a cell structure in the meat, meat by-product, fish and seafood processing food industry for the purpose of optimizing and/or reducing processing steps,
characterized by
applying an electric field having a field strength of >0.5 kV/cm and inputting energy into the cell structure product to be treated, with an upper energy limit that excludes the occurrence of thermally caused modifications in the product;
electroporating the cell membrane and consequently eliminating the barrier to the transportation of substances between the cell interior and the exterior and the individual cells;
an accelerated and uniformly distributed absorption of liquid media by the created porous matrix of meat, meat by-product, seafood and fish cells, wherein additional substances determining the product properties may be dissolved or contained in the liquid medium.

2. Method according to claim 1,
characterized in that
the electroporation is carried out in a liquid bath provided with electrodes.

3. Method according to claim 1,
characterized in that
alternatively or supplementally to the conductive liquid bath the electric field is generated by contact electrodes.

4. Method according to claim 3,
characterized in that
different types of electrodes are applied (needle, plate, roller, cannula, waffle, grid, hollow, flow type electrodes).

5. Method according to claim 1,
characterized in that
the electroporation is carried out before, during or after a liquid injection step.

6. Method according to claim 1,
characterized in that
the electroporation is carried out before, during or after the mixing and/or mincing of the individual components according to a recipe.

7. Method according to claim 1,
characterized in that
the treatment is carried with minced raw materials.

8. Method according to claim 1,
characterized in that
the treated raw product serves the production of other products (e.g. jellied meat) as fresh meat or, after having been heated, as raw material.

9. Method according to claim 1,
characterized in that
the treated raw product is further processed to raw, cooked, jellied or scalded sausages.

10. Method according to claim 1,
characterized in that
spices, salts, probiotic substances, technical auxiliary substances or the like substances are added to the liquid medium.

11. Method according to claim 1,
characterized in that
the electroporation is followed by a step of accelerated removal of cell fluid by applying suitable driving forces, especially vacuum influence, concentration gradients by applying electrolytes or dry air or mechanical influences.

12. Method according to claim 1,
characterized by
using, for the purpose of tenderizing, raw meat as raw material for the production of other products (e.g. raw cured products).

13. Method according to claim 1,
characterized in that
a pulsed electric field is generated during the electroporation.

14. Method according to claim 2,
characterized in that
alternatively or supplementally to the conductive liquid bath the electric field is generated by contact electrodes.

15. Method according to claim 2,
characterized in that
the treatment is carried with minced raw materials.

16. Method according to claim 3,
characterized in that
the treatment is carried with minced raw materials.

17. Method according to claim 4,
characterized in that
the treatment is carried with minced raw materials.

18. Method according to claim 5,
characterized in that
the treatment is carried with minced raw materials.

19. Method according to claim 6,
characterized in that
the treatment is carried with minced raw materials.

20. Method according to claim 2,
characterized in that
the treated raw product serves the production of other products (e.g. jellied meat) as fresh meat or, after having been heated, as raw material.
